(19) United States
(12) Patent Application Publication
(10) Pub. No.: US 2021/0094534 A1
(43) Pub. Date: Apr. 1, 2021

(54) APPARATUS AND METHOD FOR IMPROVING RIDE COMFORT OF VEHICLE

(71) Applicants: HYUNDAI MOTOR COMPANY, Seoul (KR); KIA MOTORS CORPORATION, Seoul (KR); Korea University of Technology And Education Industry-University Cooperation Foundation, Cheonan-si (KR)

(72) Inventors: Dong Yoon HYUN, Seoul (KR); Joung Hee LEE, Hwaseong-si (KR); Seung Han YOU, Seoul (KR)

(73) Assignees: HYUNDAI MOTOR COMPANY, Seoul (KR); KIA MOTORS CORPORATION, Seoul (KR); Korea University Of Technology And Education Industry-University Cooperation Foundation, Cheonan-si (KR)

(21) Appl. No.: 17/026,600

(22) Filed: Sep. 21, 2020

(30) Foreign Application Priority Data
Sep. 27, 2019 (KR) 10-2019-0119563

(51) Int. Cl. B60W 30/02; B60W 10/22; B60W 10/18

(52) U.S. Cl. CPC B60W 30/025; B60G 17/0164; B60W 10/18; B60W 10/22

(57) ABSTRACT

An apparatus for improving ride comfort of a vehicle includes: a sensing unit to sense whether an obstacle is present in a traveling direction of the vehicle and a quantity of behavior of the vehicle; a control value calculation unit to calculate control values for controlling the vehicle in a vertical direction and a pitch direction based on information sensed by the sensing unit; and a driving controller to control at least one of front wheels or rear wheels of the vehicle based on the calculated vertical-direction control values and pitch-direction control values. In particular, each of the vertical-direction control value and the pitch-direction control value includes a control value related to driving and braking the vehicle.

### CROSS-REFERENCE TO RELATED APPLICATION

This application claims priority to and the benefit of Korean Patent Application No. 10-2019-0119563, filed on Sep. 27, 2019, the entire contents of which are incorporated herein by reference.

### FIELD

The present disclosure relates to an apparatus and method for controlling a vehicle to improve ride comfort of the vehicle.

### BACKGROUND

The statements in this section merely provide background information related to the present disclosure and may not constitute prior art.

An electric driving motor applied to an electric vehicle is a device that generates driving force to rotate wheels of the vehicle. The electric driving motor replaces a conventional internal combustion engine for a vehicle. The electric driving motor has an advantage of generating required torque more rapidly and accurately than the engine of the internal combustion engine vehicle. In addition, the electric driving motor may be applied to each wheel, whereby front and rear wheels of the electric vehicle may be independently driven or braked. For this reason, research and development have been actively conducted on technology for controlling a body of the vehicle when the vehicle turns using excellent controllability and independent driving force of the electric driving motor in the electric vehicle field.

A vehicle in the related art, simultaneously controlling a pitch-direction motion and a vertical-direction motion, which are correlated to each other, was not considered. Instead, controlling only one of the pitch-direction motion and vertical-direction motion was discussed. Since ride comfort is affected by the maximum peaks of the two motions, it is advantageous to reduce the maximum peaks in terms of control. Conventionally, a passenger feels a sense of difference when a vehicle passes through an obstacle as the result of driving and braking control performed without consideration of the maximum peaks of the two motions.

The above information disclosed in this Background section is provided only for enhancement of understanding of the background of the disclosure and therefore it may contain information that does not form the prior art that is already known to a person of ordinary skill in the art.

### SUMMARY

The present disclosure provides an apparatus and a method capable of controlling a vehicle both in a pitch direction and in a vertical direction to improve ride comfort of the vehicle.

The present disclosure also provides an apparatus and a method capable of controlling a vehicle according to a mode for vertical-direction control and then controlling vehicle according to a mode for pitch-direction control in order to solve a problem that may occur when only pitch-direction control is performed.

The objects of the present disclosure are not limited to those described above. The objects of the present disclosure will be clearly understood from the following description and could be implemented by means defined in the claims and a combination thereof.

In one aspect of the present disclosure, an apparatus for improving ride comfort of a vehicle may include: a sensing unit configured to sense whether an obstacle is present in a traveling direction of the vehicle and the quantity of behavior of the vehicle, a control value calculation unit configured to calculate control values for controlling the vehicle in a vertical direction and a pitch direction based on information sensed by the sensing unit, and a driving controller configured to control at least one of front wheels or rear wheels of the vehicle based on the vertical-direction control value and the pitch-direction control value calculated by the control value calculation unit, wherein each of the vertical-direction control value and the pitch-direction control value includes a control value related to driving and braking the vehicle.

In one form, the driving controller may control the vehicle based on one of a vertical-direction control mode and a pitch-direction control mode.

In another form, the apparatus may further include a control mode switch determination unit configured to determine a time at which a control mode is switched from the vertical-direction control mode of the vehicle to the pitch-direction control mode of the vehicle, wherein the control mode switch determination unit may determine a first time at which an absolute value of the quantity of behavior in the vertical direction, which is included in the quantity of behavior of the vehicle, is equal to or greater than a predetermined value, and determine the first time as a time at which the control mode is switched from the vertical-direction control mode to the pitch-direction control mode.

In an example, in the case in which an obstacle is present in the traveling direction of the vehicle, the driving controller may control the vehicle based on the vertical-direction control mode and may then control the vehicle based on the pitch-direction control mode.

In an example, the vertical-direction control mode may include: a first vertical control mode for driving the front wheels and braking the rear wheels, and a second vertical control mode for braking the front wheels and driving the rear wheels. In another form the pitch-direction control mode may include: a first pitch control mode for braking the front wheels, and a second pitch control mode for driving the front wheels and braking the rear wheels.

In some forms, in the case in which the quantity of behavior in the vertical direction, which is included in the quantity of behavior of the vehicle sensed by the sensing unit, has a positive value, the control value calculation unit may calculate the vertical-direction control value having a negative value, and the driving controller may drive the vehicle according to the first vertical control mode.

In some forms, in the case in which the quantity of behavior in the vertical direction, which is included in the quantity of behavior of the vehicle sensed by the sensing unit, has a negative value, the control value calculation unit may calculate the vertical-direction control value having a positive value, and the driving controller may drive the vehicle according to the second vertical control mode.

In some forms, in the case in which the quantity of behavior in the pitch direction, which is included in the quantity of behavior of the vehicle sensed by the sensing unit, has a negative value, the control value calculation unit may calculate the pitch-direction control value having a positive value, and the driving controller may drive the vehicle according to the first pitch control mode.

In an example, in the case in which the quantity of behavior in the pitch direction, which is included in the quantity of behavior of the vehicle sensed by the sensing unit, has a positive value, the control value calculation unit may calculate the pitch-direction control value having a negative value, and the driving controller may drive the vehicle according to the second pitch control mode.

In another form, the sensing unit may calculate the quantity of behavior of the vehicle in the pitch direction and the quantity of behavior of the vehicle in the vertical direction, and the control value calculation unit may calculate the vertical-direction control value and the pitch-direction control value based on the quantity of behavior in the pitch direction and the quantity of behavior in the vertical direction.

In other form, the driving controller may change a control mode of the vehicle based on the quantity of behavior in the pitch direction and the quantity of behavior in the vertical direction.

In some forms, the apparatus may further include: an actual torque estimation unit configured to derive a difference in a wheel speed change between the front wheels and the rear wheels in the case in which both the front wheels and the rear wheels are controlled, wherein the actual torque estimation unit may calculate a braking torque or a driving torque, which is actually applied to the front wheels and the rear wheels based on the difference in the wheel speed change between the front wheels and the rear wheels.

In an example, the apparatus may further include a longitudinal-direction torque compensation unit configured to calculate a compensation torque for maintaining a longitudinal-direction speed of the vehicle based on the braking or driving torque applied to the front wheels and the rear wheels.

In an example, the apparatus may further include a torque decision unit configured to apply the compensation torque derived by the longitudinal-direction torque compensation unit to the vertical-direction control value and the pitch-direction control value derived by the control value calculation unit in order to derive a final vertical-direction control value and a final pitch-direction control value.

In an example, the driving controller may control a torque control device configured to control the front wheels and the rear wheels based on the final vertical-direction control value and the final pitch-direction control value derived by the torque decision unit.

In another form of the present disclosure, a method of improving ride comfort of a vehicle may include: sensing, by a sensing unit, whether an obstacle is present in a traveling direction of the vehicle and the quantity of behavior of the vehicle depending on the obstacle; calculating, by a processor, vertical-direction control values for performing vertical-direction control of the vehicle based on information sensed by the sensing unit in order to control driving and braking of at least one of front wheels or rear wheels of the vehicle; changing by the processor, a control mode from a vertical-direction control mode to a pitch-direction control mode of the vehicle; and calculating by the processor, pitch-direction control values for performing the pitch-direction control based on the information sensed by the sensing unit in order to control driving and braking of at least one of the front wheels or the rear wheels of the vehicle.

In an example, the step of changing the control mode may include determining a first time at which an absolute value of the quantity of behavior in the vertical direction, which is included in the quantity of behavior of the vehicle, is equal to or greater than a predetermined value, determining the first time as a time at which the control mode is switched from the vertical-direction control mode to the pitch-direction control mode.

In an example, the vertical-direction control mode may include: a first vertical control mode for driving the front wheels and braking the rear wheels, and a second vertical control mode for braking the front wheels and driving the rear wheels. In another form, the pitch-direction control mode may include a first pitch control mode for braking the front wheels, and a second pitch control mode for driving the front wheels and braking the rear wheels.

In an example, the step of calculating the pitch-direction control values in order to control driving and braking of at least one of the front wheels or the rear wheels of the vehicle may include changing driving and braking of at least one of the front wheels or the rear wheels depending on a change in the quantity of behavior of the vehicle in the pitch direction.

In an example, the vertical-direction control values and the pitch-direction control values may be values for applying a torque in a direction opposite to a direction in which the quantity of behavior of the vehicle in the vertical direction and the quantity of behavior of the vehicle in the pitch direction are generated, and the vertical-direction control values and the pitch-direction control values may be calculated based on a compensation torque which is calculated based on a difference in a wheel speed change between the front wheels and the rear wheels.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view showing an apparatus for improving ride comfort of a vehicle in one form of the present disclosure;

FIG. 2 is a view showing a control value calculation unit in one form of the present disclosure;

FIG. 3 is a graph illustrating a method of deciding a control mode switching time in one form of the present disclosure;

FIG. 4 is a table showing a change in the behavior of a vehicle depending on control modes of the vehicle in another form of the present disclosure;

FIG. 5 is a view showing a change in the behavior of a vehicle at the time of front wheel braking in one form of the present disclosure;

FIG. 6 is a view showing a change in the behavior of a vehicle at the time of front wheel braking and rear wheel driving in another form of the present disclosure;

FIG. 7 is a view showing a change in the behavior of a vehicle at the time of front wheel driving and rear wheel braking according to an form of the present disclosure;

FIG. 8A is a graph showing a change in the quantity of behavior of a vehicle in a pitch direction depending on pitch control modes in one form of the present disclosure;

FIG. 8B is a graph showing a change in the quantity of behavior of a vehicle in a vertical direction depending on pitch control modes in another form of the present disclosure;

FIG. 9A is a graph showing a change in the quantity of behavior of a vehicle in a pitch direction depending on vertical control modes in one form of the present disclosure;

FIG. 9B is a graph showing a change in the quantity of behavior of a vehicle in a vertical direction depending on vertical control modes in another form of the present disclosure;

FIG. 10 is a graph showing a change in the quantity of behavior of a vehicle in a pitch direction in the case in which a ride comfort improvement method in one form of the present disclosure is applied;

FIG. 11 is a graph showing a change in the quantity of behavior of a vehicle in a vertical direction in the case in which a ride comfort improvement method is applied in one form of the present disclosure;

FIG. 12 illustrates graphs showing changing a control mode by period in one form of the present disclosure; and

FIG. 13 is a flowchart showing a method of improving ride comfort of a vehicle according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Advantages and features of the present disclosure and methods for achieving the same will be clearly understood with reference to the following detailed description of forms in conjunction with the accompanying drawings. However, the present disclosure is not limited to the exemplary forms disclosed herein and may be implemented in various different forms.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

In addition, relational terms, such as “first” and “second,” are used in this specification only to distinguish between the same elements, and the elements are not limited as to the sequence therebetween in the following description.

The above detailed description illustrates the present disclosure. In addition, the foregoing describes exemplary forms of the present disclosure. The present disclosure may be used in various different combinations, changes, and environments. That is, variations or modifications can be made within the conceptual scope of the present disclosure, equivalents to the disclosure of the present disclosure, and/or the scope of technology and knowledge in the art to which the present disclosure pertains. The forms describe the best mode for realizing the technical concept of the present disclosure, and variations desired for the concrete application and use of the present disclosure are possible. Therefore, the above detailed description does not limit the present disclosure disclosed above

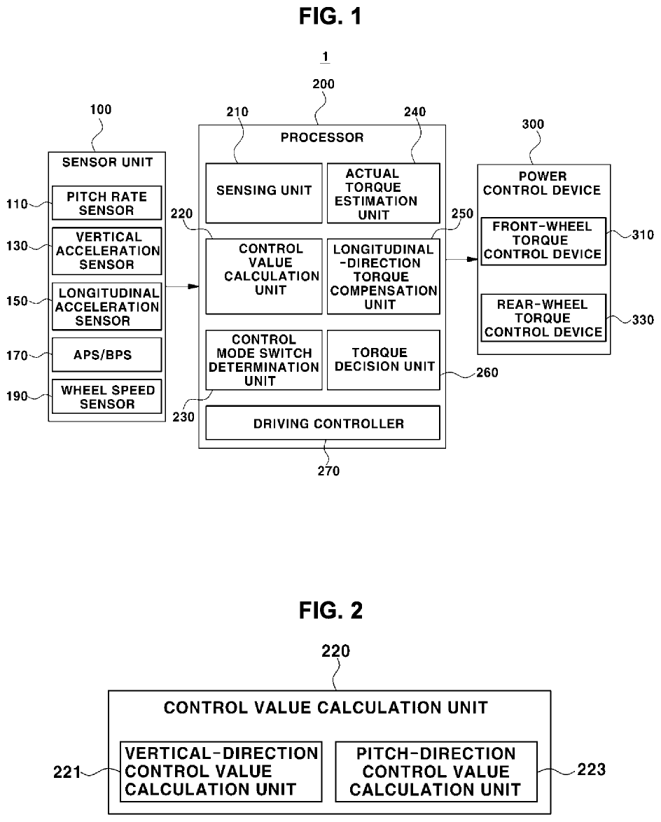

FIG. 1 is a view showing an apparatus for improving ride comfort of a vehicle in one form of the present disclosure, and FIG. 2 is a view showing a control value calculation unit according to one form of the present disclosure.

Referring to FIGS. 1 and 2, the apparatus 1 for improving ride comfort of the vehicle may include a sensor unit 100, a processor 200, and a power control device 300. The ride comfort improvement apparatus 1 may control driving force and braking force of the vehicle and may change a control mode of the vehicle based on a change in the quantity of behavior of the vehicle in order to improve ride comfort of the vehicle.

The sensor unit 100 may include a pitch rate sensor 110, a vertical acceleration sensor 130, a longitudinal acceleration sensor 150, an APS (accelerator pedal position sensor)/BPS (brake position sensor) 170, and a wheel speed sensor 190.

The pitch rate sensor 110 may sense a change in pitch rate, which is included in a change in behavior of the vehicle. The pitch rate may mean pitch angular speed of the vehicle. The pitch rate indicates rotation of the vehicle about a lateral axis of the vehicle that passes through the center of gravity of the vehicle. In the case in which the vehicle is not rotated about the lateral axis of the vehicle, the pitch rate sensor 110 may generate a signal indicating that the pitch rate is 0. That is, the pitch rate sensor 110 may sense occurrence of a phenomenon in which the vehicle leans forwards or rearwards in a traveling direction of the vehicle. A value sensed by the pitch rate sensor 110 may be expressed using an angle.

The vertical acceleration sensor 130 may sense a change in acceleration in a direction perpendicular to the traveling direction of the vehicle (i.e. a direction of gravity). The quantity of behavior of the vehicle in a vertical direction may be calculated based on a value sensed by the vertical acceleration sensor 130. The vertical acceleration sensor 130 may be mounted to front wheels or a body of the vehicle, but the position thereof is not particularly restricted.

The longitudinal acceleration sensor 150 may sense longitudinal acceleration of the vehicle in the forward-rearward direction thereof. A value sensed by the longitudinal acceleration sensor 150 may be used to determine whether an obstacle is present in front of the vehicle.

The APS/BPS 170 may include a brake position sensor (BPS) installed at a brake pedal to detect the position of the brake pedal and an accelerator pedal position sensor (APS) installed at an accelerator pedal to detect the position of the accelerator pedal.

The wheel speed sensor 190 may sense a change in speed of the vehicle in the longitudinal direction thereof. The wheel speed sensor 190 may be disposed at each of the front and rear wheels of the vehicle. That is, the wheel speed sensor 190 may sense a front wheel speed and a rear wheel speed.

In addition, the sensor unit 100 may include a camera, radar, or lidar for sensing an obstacle disposed in the traveling direction of the vehicle.

The processor 200 may include a sensing unit 210, a control value calculation unit 220, a control mode switch determination unit 230, an actual torque estimation unit 240, a longitudinal-direction torque compensation unit 250, a torque decision unit 260, and a driving controller 270. The processor 200 may include an electronic control unit (ECU) mounted to the vehicle. The processor 200 may process information sensed by the sensing unit 100, and may control the power control device 300 based on the processed information. When the vehicle passes through an obstacle, the processor 200 may perform control in the vertical direction of the vehicle and may then perform control in a pitch direction of the vehicle. In order to perform control as described above, it is desired to decide a control mode and to switch the control mode, and the quantity of driving or braking applied to the front and rear wheels of the vehicle must be calculated.

The sensing unit 210 may sense whether an obstacle is present in the traveling direction of the vehicle and the quantity of behavior of the vehicle based on the information sensed by the sensor unit 100. The quantity of behavior of the vehicle may mean the extent to which the vehicle moves in the pitch direction and the vertical direction when passing through an obstacle. The quantity of behavior of the vehicle may include the quantity of behavior of the vehicle in the pitch direction and the quantity of behavior of the vehicle in the vertical direction. An obstacle may mean a speed bump disposed on a road on which the vehicle travels or a pot hole in the road. In the case in which vertical acceleration of the wheels measured using the vertical acceleration sensor 130 mounted to the wheels is equal to or more than a predetermined value or in the case in which acceleration values sensed by the longitudinal acceleration sensor 150 mounted to the vehicle and the vertical acceleration sensor 130 are configured as a two-dimensional vector and overall acceleration obtained by calculating the same is equal to or more than a predetermined value, the sensing unit 210 may determine that impact applied to the vehicle has been sensed. In the case in which a pitch rate having a predetermined value or more continues for a predetermined time within a predetermined time immediately after sensing of the impact, the sensing unit 210 may determine that the vehicle is passing through an obstacle. That is, the sensing unit 210 may determine whether impact has been applied to the vehicle based on the acceleration value, and may determine that an obstacle is present in the traveling direction of the vehicle in the case in which the pitch rate is a predetermined value or more and is sensed continuously for a predetermined time or more. In addition, the sensing unit 210 may sense the quantity of behavior of the vehicle based on the values sensed by the pitch rate sensor 110 and the vertical acceleration sensor 130.

Furthermore, whether an obstacle is present in the traveling direction of the vehicle may be sensed by the camera, radar, or lidar.

The control value calculation unit 220 may calculate a control value for controlling the vehicle based on the quantity of behavior of the vehicle sensed by the sensing unit 210. The control value calculation unit 220 may include a vertical-direction control value calculation unit 221 that calculates a control value for controlling motion in the vertical direction and a pitch-direction control value calculation unit 223 that calculates a control value for controlling motion in the pitch direction.

The vertical-direction control value calculation unit 221 may pass vertical-direction acceleration sensed by the vertical acceleration sensor 130 through a low pass filter (LPF) so as to be filtered, and may integrate the filtered vertical-direction acceleration in order to calculate vertical-direction speed. The vertical-direction acceleration is passed through the low pass filter (LPF) in order to prevent divergence due to offset of the sensor. The vertical-direction control value calculation unit 221 may calculate a vertical-direction control value for controlling motion of the vehicle based on the calculated vertical-direction speed. The vertical-direction control value may be calculated using a proportional control method or a proportional differential control method. The maximum of the vertical-direction control value may be limited in order to prevent a driver from feeling a sense of difference. In an example, in the case in which the current quantity of behavior of the vehicle in the vertical direction has a positive value, the vertical-direction control value may have a negative value.

The pitch-direction control value calculation unit 223 may calculate a pitch-direction control value for controlling motion of the vehicle based on the pitch rate sensed by the pitch rate sensor 110. The pitch-direction control value may be calculated using a proportional control method or a proportional differential control method. The maximum of the pitch-direction control value may be limited in order to prevent a driver from feeling a sense of difference. In an example, in the case in which the current quantity of behavior of the vehicle in the pitch direction has a positive value, the pitch-direction control value may have a negative value.

The control mode switch determination unit 230 may determine a time at which the control mode is switched from a mode for vertical-direction control of the vehicle to a mode for pitch-direction control of the vehicle. In one form, the control mode switch determination unit 230 may determine a time at which the control mode is switched from the mode for vertical-direction control of the vehicle to the mode for pitch-direction control of the vehicle based on information about the pitch rate and the vertical acceleration of the vehicle.

The actual torque estimation unit 240 may calculate a table for estimating torque applied to the front and rear wheels of the vehicle. In the case in which torque for controlling the vehicle is applied to both the front and rear wheels, the actual torque estimation unit 240 may calculate an estimated value of control torque actually applied to the front and rear wheels through a difference in a wheel speed change between the front and rear wheels. The control torque may include braking torque for braking the vehicle and driving torque for driving the vehicle. The estimated value of control torque to the front and rear wheels may be calculated as a lookup table about an estimated value of normal drag of the front wheels/rear wheels and vehicle speed. In an example, the normal drag may be estimated based on the quantity of behavior of the vehicle in the vertical direction, and the estimated value of control torque to the front and rear wheels may be calculated based on distribution torque distributed to the front and rear wheels of the vehicle, the estimated value of the normal drag, and a change in speed of the front and rear wheels.

The longitudinal-direction torque compensation unit 250 may calculate compensation torque for maintaining the longitudinal-direction speed of the vehicle based on the estimated value of control torque to the front and rear wheels calculated by the actual torque estimation unit 240. The compensation torque may be a value applied in order to prevent a passenger from feeling a sense of difference as the vehicle is decelerated when the vehicle passes through an obstacle. The compensation torque may be used in order to derive a control value that is actually applied to the front and rear wheels of the vehicle.

The torque decision unit 260 may apply the compensation torque derived by the longitudinal-direction torque compensation unit 250 to the vertical-direction control value and the pitch-direction control value derived by the control value calculation unit 220 in order to derive a final vertical-direction control value and a final pitch-direction control value. The final vertical-direction control value and the final pitch-direction control value may be torque values applied to brake and drive the front and rear wheels of the vehicle. For example, in the case in which the control value calculation unit 220 calculates a control value of +100 Nm for the front wheels and a control value of −100 Nm for the rear wheels and in the case in which the longitudinal-direction torque compensation unit 250 calculates a compensation torque of +10 Nm, the torque decision unit 260 may apply a compensation torque of +5 Nm to the front wheels and may apply a compensation torque of +5 Nm to the rear wheels. The torque decision unit 260 may calculate a control value of +105 Nm for the front wheels and −95 Nm for the rear wheels, obtained by applying the compensation torque, as a final control value. The final control value may be a vertical-direction control value or a pitch-direction control value. That is, the torque decision unit 260 may apply the compensation torque to calculate a final vertical-direction control value in a period for performing vertical-direction control, and may apply the compensation torque to calculate a final pitch-direction control value in a period for performing pitch-direction control.

The driving controller 270 may control at least one of the front wheels or the rear wheels of the vehicle based on the final control value. The final control value may be a vertical-direction control value or a pitch-direction control value, and each of the vertical-direction control value and the pitch-direction control value may include a control value related to driving and braking. The driving controller 270 may control the power control device 300 based on the final control value.

In addition, the driving controller 270 may change the control mode of the vehicle based on the quantity of behavior in the pitch direction and the quantity of behavior in the vertical direction. The control mode of the vehicle may be stored in a control mode table (not shown) in advance. The driving controller 270 may change the control mode of the vehicle based on one of the mode for vertical-direction control and the mode for pitch-direction control. In one form, in the case in which an obstacle is present in the traveling direction of the vehicle, the driving controller 270 may control the vehicle according to the mode for vertical-direction control and may then control the vehicle according to the mode for pitch-direction control. The mode for vertical-direction control may include a first vertical control mode for driving the front wheels and braking the rear wheels and a second vertical control mode for braking the front wheels and driving the rear wheels. The mode for pitch-direction control may include a first pitch control mode for braking the front wheels and a second pitch control mode for driving the front wheels and braking the rear wheels.

In an example, in the case in which the quantity of behavior in the vertical direction, which is included in the quantity of behavior of the vehicle sensed by the sensing unit 210, has a positive value, the control value calculation unit 220 may calculate a vertical-direction control value having a negative value. At this time, the driving controller 270 may move the vehicle according to the first vertical control mode.

In an example, in the case in which the quantity of behavior in the vertical direction, which is included in the quantity of behavior of the vehicle sensed by the sensing unit 210, has a negative value, the control value calculation unit 220 may calculate a vertical-direction control value having a positive value. At this time, the driving controller 270 may move the vehicle according to the second vertical control mode.

In an example, in the case in which the quantity of behavior in the pitch direction, which is an example of the quantity of behavior of the vehicle sensed by the sensing unit 210, has a negative value, the control value calculation unit 220 may calculate a pitch-direction control value having a positive value. At this time, the driving controller 270 may move the vehicle according to the first vertical control mode.

In an example, in the case in which the quantity of behavior in the pitch direction, which is an example of the quantity of behavior of the vehicle sensed by the sensing unit 210, has a positive value, the control value calculation unit 220 may calculate a pitch-direction control value having a negative value. At this time, the driving controller 270 may move the vehicle according to the second vertical control mode.

The power control device 300 may control driving and braking of the front and rear wheels of the vehicle. The power control device 300 may include a front-wheel torque control device 310 for controlling driving and braking of the front wheels of the vehicle and a rear-wheel torque control device 330 for controlling driving and braking of the rear wheels of the vehicle. Each of the front-wheel torque control device 310 and the rear-wheel torque control device 330 may include a motor or brake connected to the wheels. That is, the front-wheel torque control device 310 and the rear-wheel torque control device 330 may apply driving force and braking force to the front wheels and the rear wheels of the vehicle under control of the driving controller 270.

In one form of the present disclosure, the ride comfort improvement apparatus 1 is capable of controlling the vehicle both in the pitch direction and the vertical direction based on the quantity of behavior of the vehicle generated when the vehicle passes through an obstacle. Consequently, it is possible to inhibit or prevent the vehicle from excessively moving in the vertical direction and the pitch direction when passing through the obstacle, thereby improving ride comfort of the vehicle.

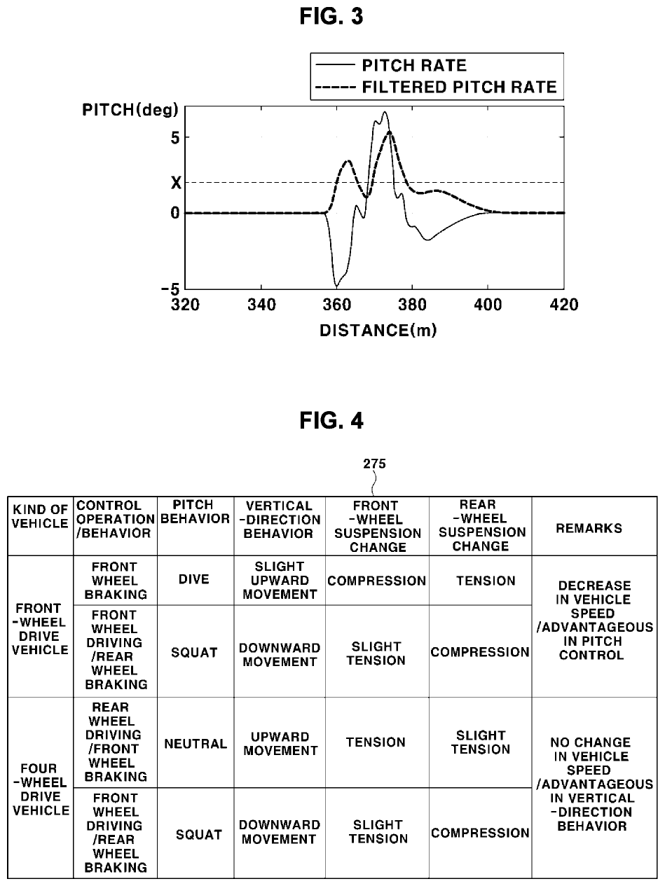

FIG. 3 is a graph illustrating a method of deciding a control mode switching time according to one form of the present disclosure.

Referring to FIGS. 1 and 3, the control mode switch determination unit 230 may determine a time at which the control mode is switched from the mode for vertical-direction control of the vehicle to the mode for pitch-direction control of the vehicle based on the pitch rate and vertical acceleration information of the vehicle.

The control mode switch determination unit 230 may determine a time at which an absolute value of the quantity of behavior in the vertical direction, which is included in the quantity of behavior of the vehicle, becomes a predetermined value X or more to be a time at which the control mode is switched from the mode for vertical-direction control of the vehicle to the mode for pitch-direction control of the vehicle. In one form, the pitch rate sensed by the pitch rate sensor 110 may be passed through the low pass filter so as to be filtered. The control mode switch determination unit 230 may compare an absolute value of the filtered pitch rate with the predetermined value X in order to determine a time at which the control mode is switched. The predetermined value X may be a value that can be changed by a designer.

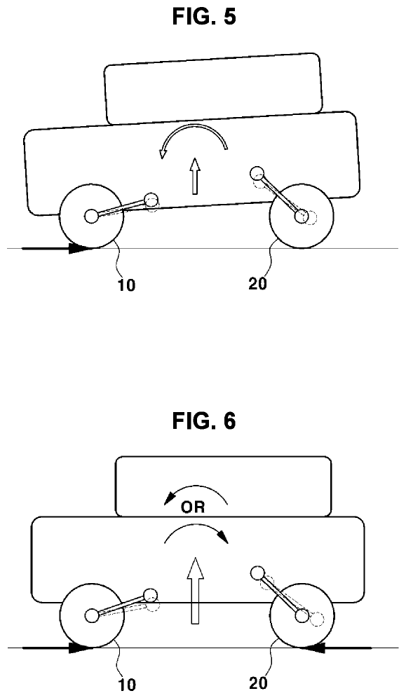

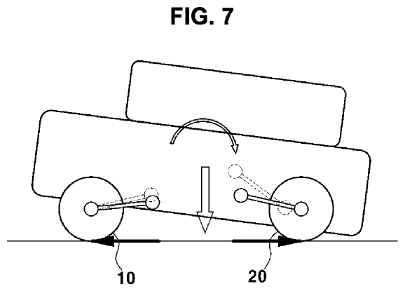

FIG. 4 is a table showing a change in the behavior of a vehicle depending on control modes of the vehicle according to one form of the present disclosure, FIG. 5 is a view showing a change in the behavior of a vehicle at the time of front wheel braking according to another form of the present disclosure, FIG. 6 is a view showing a change in the behavior of a vehicle at the time of front wheel braking and rear wheel driving in one form of the present disclosure, and FIG. 7 is a view showing a change in the behavior of a vehicle at the time of front wheel driving and rear wheel braking according to another form of the present disclosure.

FIG. 4 shows control modes capable of controlling front wheels and rear wheels of a front-wheel drive vehicle and a four-wheel drive vehicle and a change in the quantity of behavior and suspension of the vehicle during traveling in each of the control modes. Referring to a control mode table 275 of FIG. 4, the control modes applied to the front-wheel drive vehicle include front wheel braking and front wheel driving/rear wheel braking, and control modes applied to the four-wheel drive vehicle include rear wheel driving/front wheel braking and front wheel driving/rear wheel braking. The control mode for performing front wheel driving may be a first pitch control mode. Front wheel driving/rear wheel braking may be a first vertical control mode or a second pitch control mode. Rear wheel driving/front wheel braking may be a second vertical control mode.

Referring to FIGS. 4 and 5, braking may be performed using front wheels 10 during coasting. When the front wheels are braked, a dive phenomenon occurs in the vehicle in the pitch direction, and the height of the vehicle may be slightly increased in the vertical direction. At this time, a front-wheel suspension may be compressed due to the dive phenomenon in the pitch direction, and a rear-wheel suspension may be tensed due to the dive phenomenon in the pitch direction. The term “dive” may mean a phenomenon in which the vehicle leans in the traveling direction thereof, and the term “squat” may mean a phenomenon in which the vehicle leans in a direction opposite the traveling direction thereof. When front wheel braking is performed during coasting, control of the speed of the vehicle and control of the vehicle in the pitch direction may be easily performed. In the case in which a squat phenomenon occurs in the vehicle in the pitch direction, the behavior of the vehicle in the pitch direction may be stabilized according to front wheel braking. Consequently, front wheel braking may be used in order to control the vehicle in the pitch direction, and the control mode based on front wheel braking may be set to the first pitch control mode.

Referring to FIGS. 4 and 6, driving force may be applied to the front wheels 10, and braking force may be applied to rear wheels 20. At the time of front wheel driving/rear wheel braking, a squat phenomenon occurs in the vehicle in the pitch direction, and the height of the vehicle may be decreased in the vertical direction. At this time, the front-wheel suspension may be slightly tensed due to the squat phenomenon in the pitch direction, and the rear-wheel suspension may be compressed due to the squat phenomenon in the pitch direction. According to front wheel driving/rear wheel braking, control of the speed of the vehicle and control of the vehicle in the pitch direction and the vertical direction may be easily performed. In the case in which a dive phenomenon occurs in the vehicle in the pitch direction, the behavior of the vehicle in the pitch direction may be stabilized according to front wheel driving/rear wheel braking. Also, in the case in which a phenomenon in which the height of the vehicle is increased occurs, the behavior of the vehicle in the vertical direction may be stabilized according to front wheel driving/rear wheel braking. Consequently, front wheel driving/rear wheel braking may be used in order to control the vehicle in the pitch direction and the vertical direction, and the control mode based on front wheel driving/rear wheel braking may be set to the second pitch control mode or the first vertical control mode.

Referring to FIGS. 4 and 7, driving force may be applied to the rear wheels 20, and braking force may be applied to the front wheels 10. At the time of rear wheel driving/front wheel braking, a change in the quantity of behavior of the vehicle in the pitch direction may minutely occur, and the height of the vehicle may be increased in the vertical direction. At this time, the front-wheel suspension may be tensed, and the rear-wheel suspension may be slightly tensed, since the height of the vehicle is increased in the vertical direction without a change in the quantity of behavior of the vehicle in the pitch direction. According to rear wheel driving/front wheel braking, control of the vehicle in the vertical direction may be easily performed. In the case in which a phenomenon in which the height of the vehicle is decreased occurs, the behavior of the vehicle in the vertical direction may be stabilized according to rear wheel driving/front wheel braking. Consequently, rear wheel driving/front wheel braking may be used in order to control the vehicle in the vertical direction, and the control mode based on rear wheel driving/front wheel braking may be set to the second vertical control mode.

Referring to FIGS. 1 and 4, the driving controller 270 may change the control mode of the vehicle based on the quantity of behavior of the vehicle and the pre-stored control mode table 275. In order to effectively stabilize the behavior of the vehicle, however, the driving controller 270 may control the vehicle based on the mode for vertical-direction control, and may then control the vehicle based on the mode for pitch-direction control. The control of the vehicle in the pitch direction may be performed so as to correspond to a change in the quantity of behavior of the vehicle that occurs while the vehicle passes over an obstacle. That is, since a change of the vehicle in the pitch direction continuously occurs while the vehicle passes over the obstacle, the driving controller 270 may monitor the quantity of behavior of the vehicle in order to change the control mode for pitch-direction control of the vehicle.

In one form of the present disclosure, the ride comfort improvement apparatus 1 may change the control mode of the vehicle based on the pre-stored control mode table 275 and a change in the quantity of behavior of the vehicle monitored in real time. Each control mode is capable of improving stability in behavior of the vehicle in the pitch direction or the vertical direction. When an appropriate control mode is executed based on the current state of the vehicle, therefore, it is possible to improve stability in behavior of the vehicle.

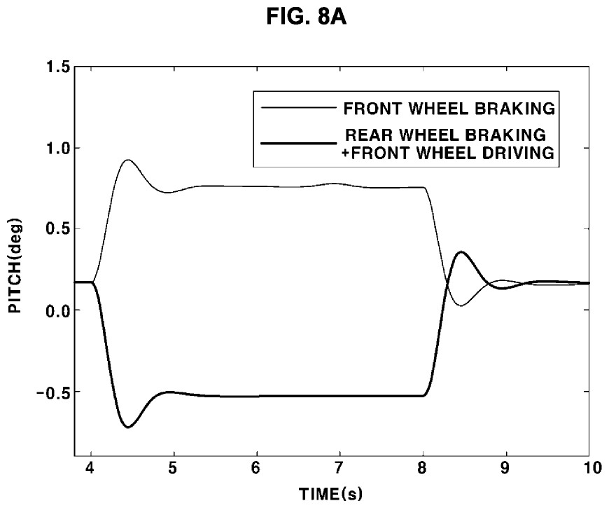

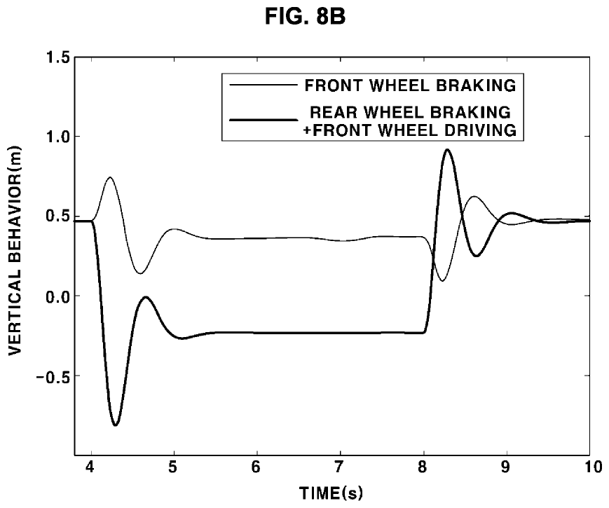

FIG. 8A is a graph showing a change in the quantity of behavior of a vehicle in a pitch direction depending on pitch control modes according to one form of the present disclosure, and FIG. 8B is a graph showing a change in the quantity of behavior of a vehicle in a vertical direction depending on pitch control modes according to another form of the present disclosure.

FIG. 8A shows a change in the quantity of behavior of the vehicle in the pitch direction at the time of front wheel braking and front wheel driving/rear wheel braking. Referring to FIG. 8A, a strong dive phenomenon occurs in the vehicle at the time of front wheel braking, and a strong squat phenomenon occurs in the vehicle at the time of front wheel driving/rear wheel braking. That is, each of control based on front wheel braking and control based on front wheel driving/rear wheel braking is a control mode advantageous for pitch-direction control.

FIG. 8B shows a change in the quantity of behavior of the vehicle in the vertical direction at the time of front wheel braking and front wheel driving/rear wheel braking. Referring to FIG. 8B, the height of the vehicle is slightly decreased or hardly decreased at the time of front wheel braking, and the height of the vehicle is decreased at the time of front wheel driving/rear wheel braking. That is, control based on front wheel braking is a control mode that is not advantageous for vertical-direction control, and control based on front wheel driving/rear wheel braking is a control mode that is advantageous for vertical-direction control.

Referring to FIGS. 1, 8A, and 8B, control of the vehicle in the pitch direction and control of the vehicle in the vertical direction cannot be simultaneously performed, and therefore the vehicle must be controlled in one of the pitch-direction control mode and the vertical-direction control mode. In the case in which a squat phenomenon occurs in the vehicle in the pitch direction, the driving controller 270 may perform front wheel braking (the first pitch control mode). In the case in which a dive phenomenon occurs in the vehicle in the pitch direction, the driving controller 270 may perform front wheel driving/rear wheel braking (the second pitch control mode).

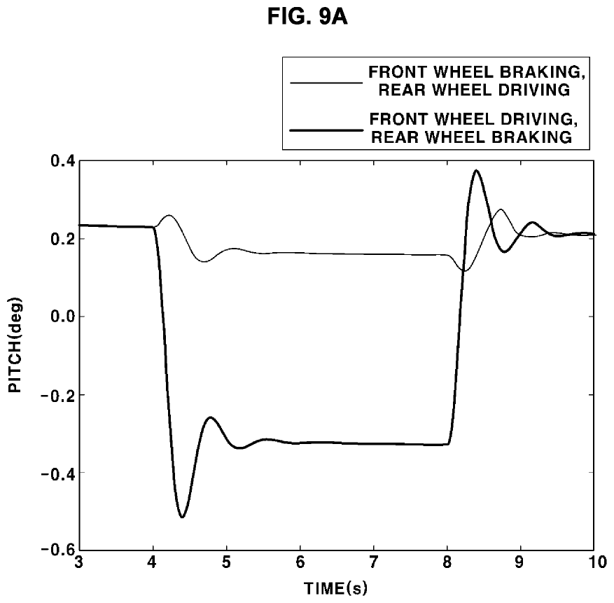

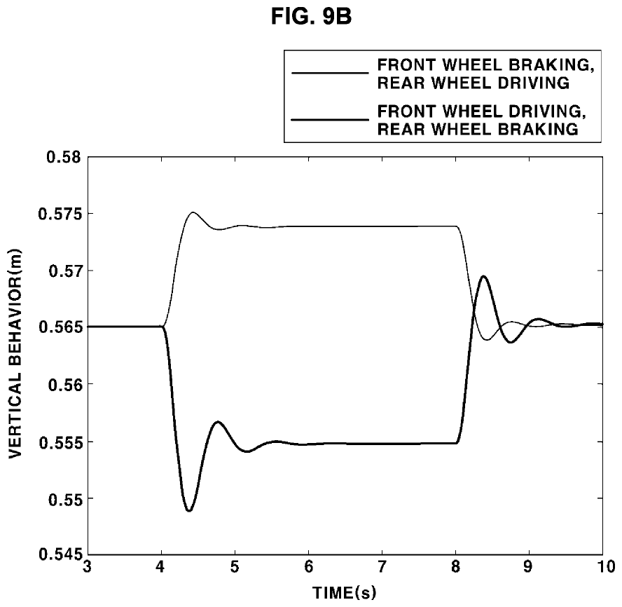

FIG. 9A is a graph showing a change in the quantity of behavior of a vehicle in a pitch direction depending on vertical control modes according to one form of the present disclosure, and FIG. 9B is a graph showing a change in the quantity of behavior of a vehicle in a vertical direction depending on vertical control modes according to another form of the present disclosure.

FIG. 9A shows a change in the quantity of behavior of the vehicle in the pitch direction at the time of rear wheel driving/front wheel braking and front wheel driving/rear wheel braking. Referring to FIG. 9A, the quantity of behavior of the vehicle in the pitch direction is minute at the time of rear wheel driving/front wheel braking, and a strong squat phenomenon occurs in the vehicle at the time of front wheel driving/rear wheel braking. That is, control based on rear wheel driving/front wheel braking is a control mode that is not advantageous for pitch-direction control of the vehicle, and control based on front wheel driving/rear wheel braking is a control mode that is advantageous for pitch-direction control of the vehicle.

FIG. 9B shows a change in the quantity of behavior of the vehicle in the vertical direction at the time of rear wheel driving/front wheel braking and front wheel driving/rear wheel braking. Referring to FIG. 9A, the height of the vehicle is increased at the time of rear wheel driving/front wheel braking, and the height of the vehicle is decreased at the time of front wheel driving/rear wheel braking. That is, each of control based on rear wheel driving/front wheel braking and control based on front wheel driving/rear wheel braking is a control mode advantageous for vertical-direction control.

Referring to FIGS. 1, 9A, and 9B, control of the vehicle in the pitch direction and control of the vehicle in the vertical direction cannot be simultaneously performed, and therefore the vehicle must be controlled in one of the pitch-direction control mode and the vertical-direction control mode. In the case in which the height of the vehicle is decreased in the vertical direction, the driving controller 270 may perform rear wheel driving/front wheel braking (the first vertical control mode). In the case in which the height of the vehicle is increased in the vertical direction, the driving controller 270 may perform front wheel driving/rear wheel braking (the second vertical control mode).

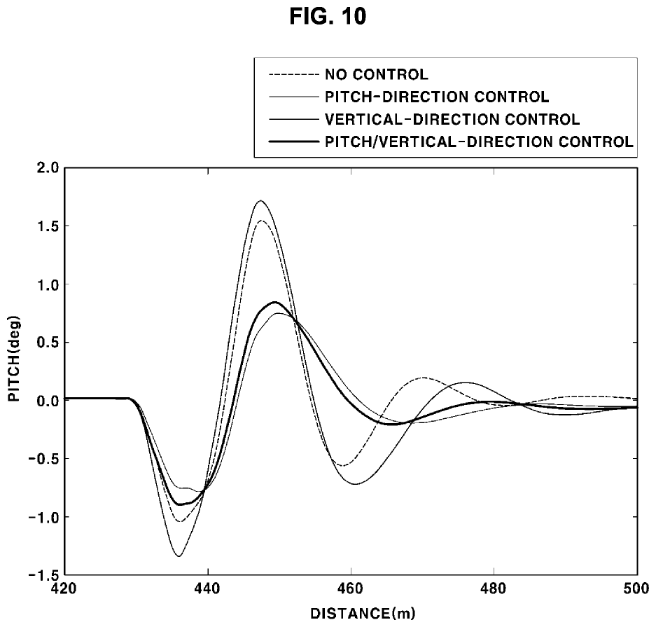

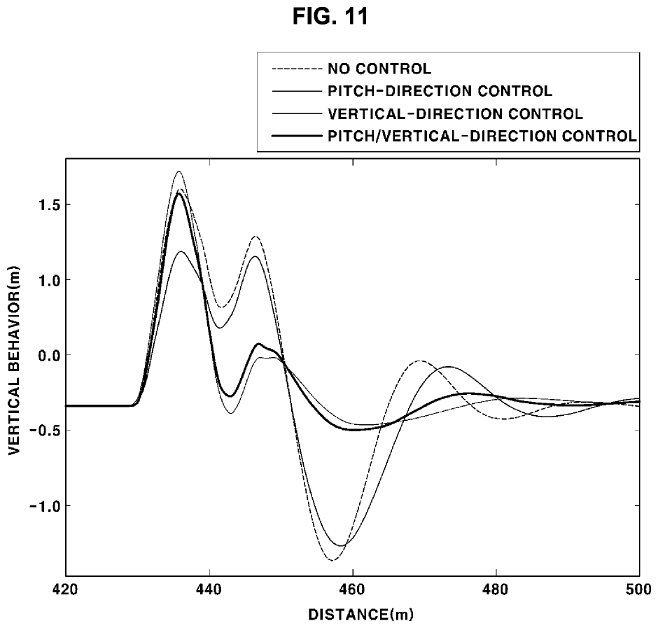

FIG. 10 is a graph showing a change in the quantity of behavior of a vehicle in a pitch direction in the case in which a ride comfort improvement method in one form of the present disclosure is applied, and FIG. 11 is a graph showing a change in the quantity of behavior of a vehicle in a vertical direction in the case in which a ride comfort improvement method in one form of the present disclosure is applied.

FIGS. 10 and 11 graphs showing changes in the quantity of behavior of the vehicle in the pitch direction and the vertical direction in the case in which the control mode of the vehicle is not changed, in the case in which only pitch-direction control is performed, in the case in which only vertical-direction control is performed, and in the case in which both pitch-direction control and vertical-direction control are performed, when the vehicle passes through an obstacle.

Referring to FIGS. 1, 10, and 11, pitch-direction control is generally superior to vertical-direction control except that a first peak in the quantity of behavior of the vehicle in the vertical direction is somewhat high. The ride comfort improvement apparatus 1 according to one form of the present disclosure may mainly perform pitch-direction control, but may perform vertical-direction control and may then perform pitch-direction control in order to solve a problem with pitch-direction control in which a first peak in the quantity of behavior of the vehicle in the vertical direction is somewhat high. In the case in which the sensing unit 210 senses that an obstacle is present in the traveling direction of the vehicle, the driving controller 270 may control the vehicle in the vertical-direction control mode, and may control the vehicle in the pitch-direction control mode after a predetermined time. As a result, a control method according to one form of the present disclosure maximally stabilizes the quantity of behavior of the vehicle in the vertical direction and the pitch direction, except for a time at which a first peak in the quantity of behavior of the vehicle in the vertical direction occurs. A time at which the control mode is switched may be determined by the control mode switch determination unit 230.

In one form of the present disclosure, the ride comfort improvement apparatus 1 may control the vehicle in the vertical-direction control mode, and may control the vehicle in the pitch-direction control mode after a predetermined time. Consequently, the ride comfort improvement apparatus 1 is capable of mainly control the vehicle in the pitch-direction control mode, which exhibits a better effect in controlling the vehicle in the vertical direction and the pitch direction while solving a problem that may occur when only pitch-direction control is performed.

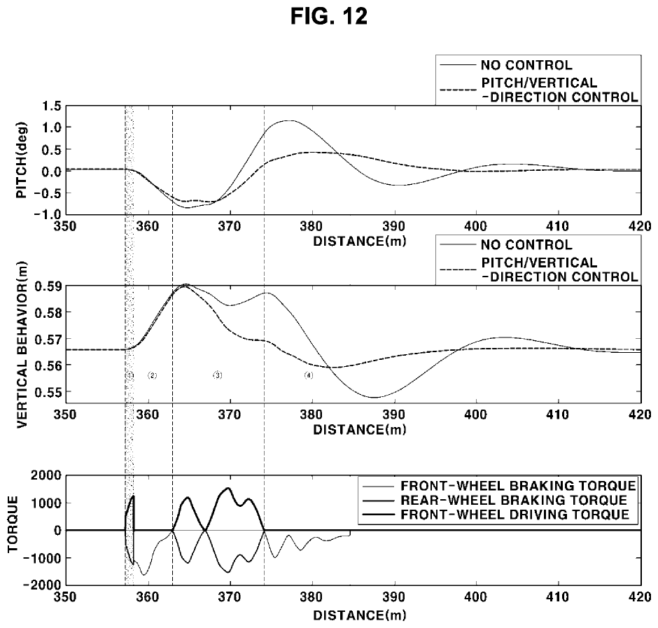

FIG. 12 is a graph showing changing a control mode by period according to one form of the present disclosure.

Referring to FIGS. 1 and 12, a period in which the control mode of the vehicle is changed may be divided into four periods.

In period \textcircled{1}, a change in the height of the vehicle may be sensed by the vertical acceleration sensor 130. At this time, the sensing unit 210 may sense that an obstacle is present in the traveling direction of the vehicle or that the vehicle is passing through the obstacle. The driving controller 270 may control the vehicle in the vertical-direction control mode. For example, since the height of the vehicle is increased, the driving controller 270 may control the vehicle in the second vertical control mode (front wheel driving/rear wheel braking), which is a mode capable of decreasing the height of the vehicle. Period \textcircled{1} may mean a period in which the front wheels of the vehicle start to pass through the obstacle.

In period \textcircled{2}, the quantity of behavior of the vehicle in the pitch direction may be sensed by the pitch rate sensor 110. The control mode switch determination unit 230 may determine a time at which an absolute value of the pitch rate (a value indicating the quantity of behavior in the vertical direction) becomes a predetermined value or more to be a time at which the control mode is switched from the mode for vertical-direction control to the mode for pitch-direction control. The driving controller 270 may control the vehicle in the mode for pitch-direction control from a time at which the control mode is switched. For example, since the quantity of behavior of the vehicle in the pitch direction has a negative value (a squat phenomenon), the driving controller 270 may control the vehicle in the first pitch control mode (front wheel braking), which is a control mode in which a dive phenomenon occurs in the vehicle, in order to inhibit or prevent the occurrence of the squat phenomenon in the vehicle. Period \textcircled{2} may mean a period in which the front wheels of the vehicle are passing through the obstacle.

In period \textcircled{3}, the quantity of behavior of the vehicle in the pitch direction may be sensed by the pitch rate sensor 110. The driving controller 270 may confirm that the quantity of behavior of the vehicle in the pitch direction is increased in a positive direction, and may control the vehicle in the second pitch control mode (front wheel driving/rear wheel braking), which is a control mode in which a squat phenomenon occurs in the vehicle, in order to prevent the occurrence of a dive phenomenon in the vehicle. Period \textcircled{3} may mean a period in which the front wheels of the vehicle have passed through the obstacle and the rear wheels of the vehicle have reached the uppermost part of the obstacle.

In period \textcircled{4}, the quantity of behavior of the vehicle in the pitch direction may be sensed by the pitch rate sensor 110. The driving controller 270 may confirm that the quantity of behavior of the vehicle in the pitch direction is increased in a negative direction, and may control the vehicle in the first pitch control mode (front wheel braking), which is a control mode in which a dive phenomenon occurs in the vehicle, in order to prevent the occurrence of a squat phenomenon in the vehicle. Period \textcircled{4} may mean a period in which the rear wheels of the vehicle have gone over the uppermost part of the obstacle.

In another form of the present disclosure, the driving controller 270 may monitor a change in the quantity of behavior of the vehicle and a change in the state of behavior of the vehicle in real time while performing pitch-direction control. That is, the driving controller 270 may not control the vehicle in a single mode for pitch-direction control but may change the control mode applied to the vehicle depending on a change in the quantity of behavior of the vehicle and a change in the state of behavior of the vehicle. Consequently, the behavior of the vehicle may be stabilized.

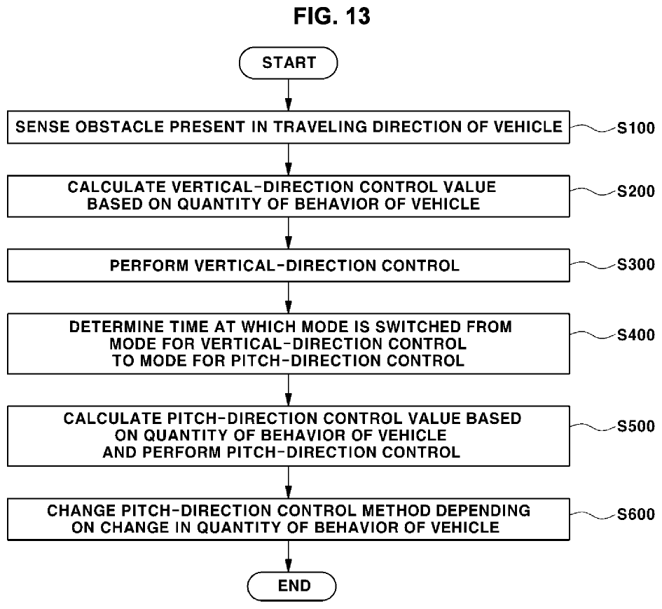

FIG. 13 is a flowchart showing a method of improving ride comfort of a vehicle according to one form of the present disclosure. For simplicity of description, duplicated statement will be omitted.

Referring to FIGS. 1 and 13, the sensing unit may sense an obstacle present in the traveling direction of the vehicle. In an example, the sensor unit may include a camera, radar, and lidar, and the sensing unit may sense whether an obstacle is present in the traveling direction of the vehicle before the vehicle passes through the obstacle based on information sensed by the sensor unit. In another example, the sensor unit may include a pitch rate sensor, a vertical acceleration sensor, and a longitudinal acceleration sensor, and the sensing unit may sense whether an obstacle is present based on impact applied to the vehicle as the vehicle passes through the obstacle and a time during which a pitch rate is changed. When a pitch rate having a predetermined value or more is continuously sensed by the sensor unit for a predetermined time after impact is applied to the vehicle, the sensing unit may determine that the obstacle is present (S100).

The control value calculation unit may calculate a vertical-direction control value based on the quantity of behavior of the vehicle in the vertical direction. In one form, the control value calculation unit may pass vertical-direction acceleration sensed by the vertical acceleration sensor through the low pass filter (LPF) so as to be filtered, and may integrate the filtered vertical-direction acceleration in order to calculate vertical-direction speed. In an example, in the case in which the current quantity of behavior of the vehicle in the vertical direction has a positive value, the vertical-direction control value may have a negative value. The control value calculation unit may calculate a vertical-direction control value for controlling motion of the vehicle based on the calculated vertical-direction speed. The vertical-direction control value may be a torque value.

The actual torque estimation unit and the longitudinal-direction torque compensation unit may calculate compensation torque, which is a value applied in order to prevent a passenger from feeling a sense of difference as the vehicle is decelerated when the vehicle passes through an obstacle. The calculated compensation torque may be applied to the vertical-direction control value by the torque decision unit, whereby a final vertical-direction control value may be derived (S200).

The driving controller may perform vertical-direction control based on the final vertical-direction control value. At this time, the driving controller may control at least one of the front wheels or the rear wheels of the vehicle based on the final vertical-direction control value. The final vertical-direction control value may be braking force or driving force applied to the vehicle.

In addition, the driving controller may select the control mode of the vehicle based on the state of behavior of the vehicle. For example, in the case in which the height of the vehicle is decreased in the vertical direction, the driving controller may perform rear wheel driving/front wheel braking (the first vertical control mode). In the case in which the height of the vehicle is increased in the vertical direction, the driving controller may perform front wheel driving/rear wheel braking (the second vertical control mode) (S300).

The driving controller may control the vehicle in the vertical-direction control mode, and may control the vehicle in the pitch-direction control mode after a predetermined time. The control mode switch determination unit may determine a time at which the control mode is switched from the mode for vertical-direction control of the vehicle to the mode for pitch-direction control of the vehicle. In one form, the control mode switch determination unit may determine a time at which an absolute value of the quantity of behavior in the vertical direction, which is included in the quantity of behavior of the vehicle, becomes a predetermined value or more to be a time at which the control mode is switched from the mode for vertical-direction control to the mode for pitch-direction control (S400).

The driving controller may control the vehicle in the mode for pitch-direction control at the control mode switch time determined by the control mode switch determination unit. At this time, the control value calculation unit may calculate a pitch-direction control value for controlling motion of the vehicle based on the pitch rate sensed by the pitch rate sensor. The pitch-direction control value may be calculated using a proportional control method or a proportional differential control method. The pitch-direction control value may be a torque value.

The actual torque estimation unit and the longitudinal-direction torque compensation unit may calculate compensation torque, which is a value applied in order to prevent a passenger from feeling a sense of difference as the vehicle is decelerated when the vehicle passes through an obstacle. The calculated compensation torque may be applied to the pitch-direction control value by the torque decision unit, whereby a final pitch-direction control value may be derived. At this time, the driving controller may control at least one of the front wheels or the rear wheels of the vehicle based on the final pitch-direction control value. The final pitch-direction control value may be braking force or driving force applied to the vehicle (S500).

The driving controller may monitor a change in the quantity of behavior of the vehicle and a change in the state of behavior of the vehicle in real time while performing pitch-direction control. In the case in which the quantity of behavior of the vehicle in the pitch direction is changed or in the case in which the state of behavior of the vehicle in the pitch direction is changed, the driving controller may control the vehicle based on a control mode suitable for the current state, among a plurality of control modes. That is, the driving controller may not control the vehicle in a single mode for pitch-direction control but may change the control mode applied to the vehicle depending on a change in the quantity of behavior of the vehicle and a change in the state of behavior of the vehicle while passing through an obstacle. Consequently, the behavior of the vehicle may be stabilized (S600).

As is apparent from the foregoing, the ride comfort improvement apparatus is capable of controlling the vehicle in both the pitch direction and the vertical direction based on the quantity of behavior of the vehicle generated when the vehicle passes through an obstacle. Consequently, it is possible to prevent the occurrence of a phenomenon in which the vehicle excessively moves in the vertical direction and the pitch direction when the vehicle passes through the obstacle.

In one form of the present disclosure, the ride comfort improvement apparatus is capable of changing the control mode of the vehicle based on the pre-stored control mode table and a change in the quantity of behavior of the vehicle monitored in real time. Each control mode is capable of improving stability in behavior of the vehicle in the pitch direction or the vertical direction. When an appropriate control mode is executed based on the current state of the vehicle, therefore, it is possible to improve stability in behavior of the vehicle.

The forms of the present disclosure have been described with reference to the accompanying drawings. However, it will be apparent to those skilled in the art that the present disclosure may be embodied in specific forms other than those set forth herein without departing from the spirit and basic principles of the present disclosure. Therefore, the above forms should be construed in all aspects as illustrative and not restrictive.

What is claimed is:

1. An apparatus for improving ride comfort of a vehicle, the apparatus comprising:
a sensing unit configured to sense a presence of an obstacle in a traveling direction of the vehicle and a quantity of behavior of the vehicle;
a control value calculation unit configured to calculate a vertical-direction control value and a pitch-direction control value to control the vehicle in a vertical direction and a pitch direction based on information sensed by the sensing unit; and
a driving controller configured to control at least one of front wheels or rear wheels of the vehicle based on the vertical-direction control value and the pitch-direction control value calculated by the control value calculation unit,
wherein each of the vertical-direction control value and the pitch-direction control value comprises a control value related to driving and braking the vehicle.

2. The apparatus according to claim 1, wherein the driving controller is configured to control the vehicle based on a vertical-direction control mode or a pitch-direction control mode.

3. The apparatus according to claim 1, further comprising:
a control mode switch determination unit configured to determine a time at which a control mode is switched from a vertical-direction control mode to a pitch-direction control mode of the vehicle,
wherein the control mode switch determination unit is configured to:
determine a first time at which an absolute value of the quantity of behavior in the vertical direction is equal to or more than a predetermined value, and
determine the first time as a time at which the control mode is switched from the vertical-direction control mode to the pitch-direction control mode.

4. The apparatus according to claim 3, wherein, when the obstacle is present in the traveling direction of the vehicle, the driving controller is configured to control the vehicle based on the vertical-direction control mode and then control the vehicle based on the pitch-direction control mode.

5. The apparatus according to claim 4, wherein:
the vertical-direction control mode comprises a first vertical control mode for driving the front wheels and braking the rear wheels, and a second vertical control mode for braking the front wheels and driving the rear wheels, and
the pitch-direction control mode comprises a first pitch control mode for braking the front wheels, and a second pitch control mode for driving the front wheels and braking the rear wheels.

6. The apparatus according to claim 5, wherein:
the quantity of behavior of the vehicle sensed by the sensing unit includes a quantity of behavior in the vertical direction,
when the quantity of behavior of the vehicle in the vertical direction has a positive value, the control value calculation unit is configured to calculate the vertical-direction control value having a negative value, and
the driving controller is configured to drive the vehicle in the first vertical control mode.

7. The apparatus according to claim 5, wherein:
the quantity of behavior of the vehicle sensed by the sensing unit includes a quantity of behavior in the vertical direction,
when the quantity of behavior of the vehicle in the vertical direction has a negative value, the control value calculation unit is configured to calculate the vertical-direction control value having a positive value, and
the driving controller is configured to drive the vehicle in the second vertical control mode.

8. The apparatus according to claim 5, wherein:
the quantity of behavior of the vehicle sensed by the sensing unit includes a quantity of behavior in the pitch direction,
when the quantity of behavior of the vehicle in the pitch direction has a negative value, the control value calculation unit is configured to calculate the pitch-direction control value having a positive value, and
the driving controller is configured to drive the vehicle in the first pitch control mode.

9. The apparatus according to claim 5, wherein:
the quantity of behavior of the vehicle sensed by the sensing unit includes a quantity of behavior in the pitch direction,
when the quantity of behavior of the vehicle in the pitch direction has a positive value, the control value calculation unit is configured to calculate the pitch-direction control value having a negative value, and
the driving controller is configured to drive the vehicle in the second pitch control mode.

10. The apparatus according to claim 1, wherein:
the sensing unit is configured to calculate a quantity of behavior of the vehicle in the pitch direction and a quantity of behavior of the vehicle in the vertical direction, and
the control value calculation unit is configured to calculate the vertical-direction control value and the pitch-direction control value based on the quantity of behavior in the pitch direction and the quantity of behavior in the vertical direction.

11. The apparatus according to claim 10, wherein the driving controller is configured to change a control mode of the vehicle based on the quantity of behavior in the pitch direction and the quantity of behavior in the vertical direction.

12. The apparatus according to claim 1, further comprising:
an actual torque estimation unit configured to derive a difference in a wheel speed change between the front wheels and the rear wheels in a case in which both the front wheels and the rear wheels are controlled,
wherein the actual torque estimation unit is configured to calculate a braking torque or a driving torque, which is actually applied to the front wheels and the rear wheels based on the difference in the wheel speed change between the front wheels and the rear wheels.

13. The apparatus according to claim 12, further comprising: a longitudinal-direction torque compensation unit configured to calculate a compensation torque for maintaining a longitudinal-direction speed of the vehicle based on the braking torque or the driving torque applied to the front wheels and the rear wheels.

14. The apparatus according to claim 13, further comprising: a torque decision unit configured to: apply the compensation torque derived by the longitudinal-direction torque compensation unit to the vertical-direction control value and the pitch-direction control value derived by the control value calculation unit so as to derive a final vertical-direction control value and a final pitch-direction control value.

15. The apparatus according to claim 14, wherein the driving controller is configured to control a torque control device configured to control the front wheels and the rear wheels based on the final vertical-direction control value and the final pitch-direction control value derived by the torque decision unit.

16. A method of improving ride comfort of a vehicle, the method comprising:
sensing, by a sensing unit, whether an obstacle is present in a traveling direction of the vehicle and a quantity of behavior of the vehicle based on the sensed obstacle;
calculating, by a processor, vertical-direction control values for performing a vertical-direction control of the vehicle based on information sensed by the sensing unit so as to control driving and braking of at least one of front wheels or rear wheels of the vehicle;
changing, by the processor, a control mode from a vertical-direction control mode to a pitch-direction control mode of the vehicle; and
calculating by the processor, pitch-direction control values for performing a pitch-direction control based on the information sensed by the sensing unit so as to control the driving and braking of at least one of the front wheels or the rear wheels of the vehicle.

17. The method according to claim 16, wherein changing the control mode comprises:
determining a first time at which an absolute value of the quantity of behavior of the in a vertical direction is equal to or greater than a predetermined value, and
determining the first time as a time at which the control mode is switched from the vertical-direction control mode to the pitch-direction control mode.

18. The method according to claim 17, wherein:
the vertical-direction control mode comprises: a first vertical control mode for driving the front wheels and braking the rear wheels, and a second vertical control mode for braking the front wheels and driving the rear wheels, and
the pitch-direction control mode comprises: a first pitch control mode for braking the front wheels, and a second pitch control mode for driving the front wheels and braking the rear wheels.

19. The method according to claim 17, wherein calculating the pitch-direction control values comprises: changing driving and braking of at least one of the front wheels or the rear wheels based on a change in the quantity of behavior of the vehicle in a pitch direction.

20. The method according to claim 17, wherein:
the vertical-direction control values and the pitch-direction control values are values for applying a torque in a direction opposite to a direction in which the quantity of behavior of the vehicle in the vertical direction and the quantity of behavior of the vehicle in a pitch direction are generated, and
the vertical-direction control values and the pitch-direction control values are calculated based on a compensation torque which is calculated based on a difference in a wheel speed change between the front wheels and the rear wheels of the vehicle.
